(19) United States
(12) Patent Application Publication
(10) Pub. No.: US 2021/0141202 A1
(43) Pub. Date: May 13, 2021

(54) MICROSCOPE DEVICE

(71) Applicant: OLYMPUS CORPORATION, Tokyo (JP)

(72) Inventor: Kanto MIYAZAKI, Tokyo (JP)

(73) Assignee: OLYMPUS CORPORATION, Tokyo (JP)

(21) Appl. No.: 17/155,345

(22) Filed: Jan. 22, 2021

Related U.S. Application Data
(63) Continuation of application No. PCT/JP2018/027954, filed on Jul. 25, 2018.

(51) Int. Cl. G02B 21/00; G02B 21/36; G02B 21/02

(52) U.S. Cl. CPC G02B 21/0076; G02B 21/02; G02B 21/361

(57) ABSTRACT

A microscope device includes a stage on which a sample is placed, an objective lens that collects fluorescence generated in the sample as a result of the sample placed on the stage being irradiated with excitation light, a phase plate through which the fluorescence collected by the objective lens is transmitted, an imaging lens that focuses the fluorescence transmitted through the phase plate, and an image acquisition element that acquires a fluorescence image of the sample focused by the imaging lens. The phase plate is disposed at a pupil position of the objective lens or at a position optically conjugate with the pupil position.

### CROSS-REFERENCE TO RELATED APPLICATIONS

This is a continuation of International Application PCT/JP2018/027954, with an international filing date of Jul. 25, 2018, which is hereby incorporated by reference herein in its entirety.

### TECHNICAL FIELD

The present invention relates to microscope devices.

### BACKGROUND ART

A known fluorescence microscope is capable of acquiring three-dimensional information of a sample (e.g., see Patent Literature 1).

### CITATION LIST

### Patent Literature

{PTL 1}
Japanese Unexamined Patent Application, Publication No. 2006-84960

### SUMMARY OF INVENTION

An aspect of the present invention is directed to a microscope device including a stage on which a sample is placed, an objective lens that collects fluorescence generated in the sample as a result of the sample placed on the stage being irradiated with excitation light, a phase plate through which the fluorescence collected by the objective lens is transmitted, an imaging lens that focuses the fluorescence transmitted through the phase plate, and an image acquisition element that acquires a fluorescence image of the sample focused by the imaging lens. The phase plate is disposed at a pupil position of the objective lens or at a position optically conjugate with the pupil position.

Another aspect of the present invention is directed to a microscope device including a light source that emits excitation light, a dichroic mirror that receives the excitation light from the light source, an objective lens that is disposed toward a sample relative to the dichroic mirror and that focuses the excitation light reflected by the dichroic mirror onto the sample, a phase plate that is disposed toward the sample relative to the dichroic mirror and at a pupil position of the objective lens or at a position optically conjugate with the pupil position and that receives the excitation light reflected by the dichroic mirror, an imaging lens that focuses fluorescence generated as a result of the sample being irradiated with the excitation light, and an image acquisition element that acquires a fluorescence image of the sample focused by the imaging lens. The fluorescence generated as a result of the sample being irradiated with the excitation light passes through the objective lens and the phase plate, enters the dichroic mirror, is transmitted through the dichroic mirror, and is focused by the imaging lens, so that the fluorescence image of the sample is formed on the image acquisition element.

### BRIEF DESCRIPTION OF DRAWINGS

FIG. 1 schematically illustrates the overall configuration of a microscope device according to an embodiment of the present invention.

FIG. 2 illustrates a first example of an objective lens provided in the microscope device in FIG. 1.

FIG. 3 illustrates the shape of a coded aperture disposed at a pupil position of the objective lens in FIG. 2.

FIG. 4 illustrates a second example of the objective lens provided in the microscope device in FIG. 1.

FIG. 5 illustrates a third example of the objective lens provided in the microscope device in FIG. 1.

FIG. 6 schematically illustrates the overall configuration of a modification of the microscope device in FIG. 1.

### DESCRIPTION OF EMBODIMENTS

A microscope device 1 according to an embodiment of the present invention will be described below with reference to the drawings.

As shown in FIG. 1, the microscope device 1 according to this embodiment includes a stage 2 on which a sample X is placed, an objective lens 4 that radiates excitation light from a light source 3 onto the sample X placed on the stage 2 and collects fluorescence generated in the sample X, a coded aperture (phase plate) 5 that is disposed at a pupil position of the objective lens 4 and allows the collected fluorescence to pass therethrough, an imaging lens 6 that focuses the fluorescence transmitted through the coded aperture 5, and an image acquisition element 7 that acquires a focused fluorescence image of the sample X.

The light source 3 emits excitation light including ultraviolet light.

In FIG. 1, reference sign 8 denotes a dichroic mirror having transmissivity such that the dichroic mirror deflects excitation light and allows fluorescence to pass therethrough, and reference sign 9 denotes a microlens array disposed between the imaging lens 6 and the image acquisition element 7 and located at an image acquisition surface of the image acquisition element 7.

The coded aperture 5 is formed of synthetic quartz that satisfies the conditional expressions indicated below:

1.43≤nd≤1.61 (1)

62≤νd≤95 (2)

where nd denotes the refractive index at the d-line, and νd denotes the Abbe number at the d-line.

The operation of the microscope device 1 according to this embodiment will be described below.

In order to acquire a three-dimensional fluorescence image of the sample X by using the microscope device 1 according to this embodiment, the sample X is placed on the stage 2, and the objective lens 4 is disposed above the sample X.

When excitation light is generated from the light source 3, the excitation light is deflected by 90° by the dichroic mirror 8, enters the objective lens 4, is focused by the objective lens 4, and is radiated onto the sample X. At the position irradiated with the excitation light in the sample X, a fluorescent material contained in the sample X is excited so that fluorescence is generated, and a portion of the fluorescence enters the objective lens 4.

The fluorescence entering the objective lens 4 is converted into substantially collimated light by the objective lens 4 and passes through the coded aperture 5 disposed at the pupil position of the objective lens 4. Then, the fluorescence converted into the substantially collimated light by the objective lens 4 passes through the dichroic mirror 8, is focused by the imaging lens 6, and then passes through the microlens array 9, so that an image of the fluorescence is acquired by the image acquisition element 7.

After the fluorescence passes through the microlens array 9, the image of the fluorescence is acquired by the image acquisition element 7, so that information about the direction of the fluorescence beam can be acquired simultaneously with the fluorescence image. This is so-called light field technology. The microscope device 1 according to this embodiment is advantageous in that it can obtain three-dimensional information of the sample X within a short period of time by using this light field technology.

Furthermore, because the depth of the fluorescence image is increased by the coded aperture 5 disposed at the pupil position of the objective lens 4, this embodiment is advantageous in that three-dimensional information of the entire fluorescence image including the focal point can be acquired so as to supplement the light field technology.

In this case, since synthetic quartz that satisfies conditional expressions (1) and (2) is used as the material of the coded aperture 5 in this embodiment, the occurrence of autofluorescence can be suppressed even if excitation light including ultraviolet light is radiated. This is advantageous in that a situation where the fluorescence from the sample X contains autofluorescence as stray light can be prevented, so that a clear three-dimensional fluorescence image of the sample X can be acquired.

Furthermore, in this embodiment, the coded aperture 5 can be disposed at the pupil position of the objective lens 4 by adjusting the synthetic quartz. This is advantageous in that a compact microscope device 1 can be provided.

### First Example

Next, a first example of the objective lens 4 used in the microscope device 1 according to this embodiment will be described with reference to FIGS. 2 and 3 and lens data indicated below.

As shown in FIG. 2, in the following order from the image side, the objective lens 4 according to this example is constituted of a convex-plano lens 41 having a convex surface at the image side, a combined lens 42 with a combination of a biconvex lens and a biconcave lens, a flat glass plate constituting the coded aperture 5, a combined lens 43 with a combination of a biconcave lens and a biconvex lens, a plano-convex lens 44 having a flat surface at the image side, and a convex-plano lens 45 having a convex surface at the image side.

| Surface No. | r | d | nd | νd |
|---|---|---|---|---|
| 1 | 25.0153 | 2.0000 | 1.7380 | 32.26 |
| 2 | 292.9546 | 12.6145 | | |
| 3 | 10.3060 | 1.3797 | 1.6779 | 55.34 |
| 4 | −15.2096 | 0.5500 | 1.7380 | 32.26 |
| 5 | 6.9967 | 1.0000 | | |
| 6 | ∞ | 1.0000 | 1.4585 | 67.80 |
| 7 | ∞ | 1.0000 | | |
| 8 | −8.2426 | 0.5500 | 1.7380 | 32.26 |
| 9 | 9.1210 | 1.3985 | 1.6779 | 55.34 |
| 10 | −11.8561 | 7.7073 | | |
| 11 | 340.5246 | 2.0000 | 1.7410 | 52.64 |
| 12 | −16.0238 | 0.1000 | | |
| 13 | 18.7919 | 2.0000 | 1.8040 | 46.58 |
| 14 | 2582.3521 | 12.0000 | | |

The focal length of the objective lens 4 is 20 mm, and the numerical aperture is 0.25.

In the lens data above, the surface number 7 corresponds to the coded aperture 5, and the radius of curvature r is indicated as ∞. However, the actual shape is as follows:

z=2.29×10⁻¹¹(x³+y³) (3)

where z denotes the direction of the optical axis, x and y denote directions orthogonal to the optical axis, and the unit is μm.

The shape of the coded aperture 5 is shown in FIG. 3. In FIG. 3, a region surrounded by a line indicates an effective diameter region.

The material of the flat glass plate is synthetic quartz or another glass material with little autofluorescence.

The objective lens 4 is object-space telecentric, and the coded aperture 5 is disposed near the pupil position where the principal ray meets the optical axis.

According to this lens data, the coded aperture 5 satisfies conditional expressions (1) and (2).

### Second Example

Next, a second example of the objective lens 4 used in the microscope device 1 according to this embodiment will be described with reference to FIG. 4 and lens data indicated below.

As shown in FIG. 4, in the following order from the image side, the objective lens 4 according to this example is constituted of a convexo-concave lens 51 having a convex surface at the image side, a plano-concave lens 52 having a flat surface at the image side, a combined lens 53 with a combination of two meniscus lenses each having a concave surface at the image side, a combined lens 54 with a combination of a biconcave lens and a biconvex lens, a combined lens 55 with a combination of a biconvex lens and a meniscus lens, a flat glass plate constituting the coded aperture 5, a combined lens 56 with a combination of two meniscus lenses each having a convex surface at the image side and a biconvex lens, a meniscus lens 57 having a convex surface at the image side, a meniscus lens 58 having a convex surface at the image side, and a flat glass plate 59.

| Surface No. | r | d | nd | νd |
|---|---|---|---|---|
| S1 | 9.4856 | 4.0021 | 1.7380 | 32.26 |
| S2 | 44.6040 | 1.3826 | | |
| S3 | 123.6400 | 1.5550 | 1.5163 | 64.14 |
| S4 | 5.2208 | 4.2338 | | |
| S5 | −5.1821 | 1.0629 | 1.7380 | 32.26 |
| S6 | −14.4055 | 5.0923 | 1.5952 | 67.74 |
| S7 | −7.7045 | 0.1000 | | |
| S8 | −20.3293 | 0.7064 | 1.6730 | 38.15 |
| S9 | 18.3759 | 4.5922 | 1.4388 | 94.95 |
| S10 | −13.5171 | 3.5332 | | |
| S11 | 18.3274 | 6.2265 | 1.4388 | 94.95 |
| S12 | −8.5895 | 1.8470 | 1.6378 | 42.41 |
| S13 | −111.9647 | 0.1474 | | |
| S14 | ∞ | 1.0000 | 1.4585 | 67.80 |
| S15 | ∞ | 0.1474 | | |
| S16 | 12.8936 | 3.6828 | 1.4388 | 94.95 |
| S17 | 111.3686 | 0.7424 | 1.6378 | 42.41 |
| S18 | 9.3695 | 6.7753 | 1.4388 | 94.95 |
| S19 | −15.2624 | 0.1000 | | |
| S20 | 6.8341 | 4.2468 | 1.8040 | 46.58 |
| S21 | 8.5535 | 0.1229 | | |
| S22 | 3.4561 | 3.5247 | 1.8830 | 40.77 |
| S23 | 1.4000 | 0.4000 | 1.4585 | 67.80 |
| S24 | ∞ | 0.3200 | 1.4041 | 51.90 |
| S25 | ∞ | 0.1700 | 1.4585 | 67.80 |

The focal length of the objective lens 4 is 4.5 mm, and the numerical aperture is 1.25.

In the lens data above, the surface number 15 corresponds to the coded aperture 5, and the radius of curvature r is indicated as ∞. However, the actual shape is as indicated in expression (3) and FIG. 3.

The material of the flat glass plate is synthetic quartz or another glass material with little autofluorescence.

The objective lens 4 is object-space telecentric, and the coded aperture 5 is disposed near the pupil position where the principal ray meets the optical axis.

According to this lens data, the coded aperture 5 satisfies conditional expressions (1) and (2).

### Third Example

Next, a third example of the objective lens 4 used in the microscope device 1 according to this embodiment will be described with reference to FIG. 5 and lens data indicated below.

As shown in FIG. 5, in the following order from the image side, the objective lens 4 according to this example is constituted of a flat glass plate constituting the coded aperture 5, a meniscus lens 61 having a concave surface at the image side, a biconvex lens 62, a meniscus lens 63 having a concave surface at the image side, a combined lens 64 with a combination of a meniscus lens having a convex surface at the image side, a biconvex lens, and a biconcave lens, a biconvex lens 65, a meniscus lens 66 having a convex surface at the image side, and a meniscus lens 67 having a convex surface at the image side.

| Surface No. | r | d | nd | νd |
|---|---|---|---|---|
| S1 | ∞ | 2.0000 | 1.5163 | 64.14 |
| S2 | ∞ | 2.0000 | | |
| S3 | −8.5000 | 0.4600 | 1.5163 | 64.14 |
| S4 | −17.7969 | 0.1000 | | |
| S5 | 25.9886 | 2.1310 | 1.7380 | 32.26 |
| S6 | −26.8723 | 1.3536 | | |
| S7 | −13.3818 | 4.8626 | 1.4970 | 81.55 |
| S8 | −11.6780 | 0.1000 | | |
| S9 | 18.3631 | 0.4600 | 1.6730 | 38.15 |
| S10 | 6.5862 | 4.3664 | 1.4970 | 81.55 |
| S11 | −7.0381 | 1.9931 | 1.6730 | 38.15 |
| S12 | 57.3994 | 0.1173 | | |
| S13 | 12.2679 | 5.0000 | 1.4388 | 94.95 |
| S14 | −14.8618 | 0.1000 | | |
| S15 | 11.1001 | 1.1271 | 1.6779 | 55.34 |
| S16 | 34.2081 | 0.1000 | | |
| S17 | 6.1519 | 3.5138 | 1.8830 | 40.77 |
| S18 | 3.5000 | 2.5005 | | |

The focal length of the objective lens 4 is 9 mm, and the numerical aperture is 0.5.

In the lens data above, the surface number 2 corresponds to the coded aperture 5, and the radius of curvature r is indicated as ∞. However, the actual shape is as indicated in expression (3) and FIG. 3.

The material of the flat glass plate is synthetic quartz or another glass material with little autofluorescence.

The objective lens 4 is object-space telecentric, and the coded aperture 5 is disposed near the pupil position where the principal ray meets the optical axis.

According to this lens data, the coded aperture 5 satisfy conditional expressions (1) and (2).

In this embodiment, the coded aperture 5 is disposed at the pupil position of the objective lens 4, so that the microscope device 1 can be made compact, and the occurrence of stray light caused by ultraviolet light is suppressed owing to the selection of synthetic quartz. Alternatively, as shown in FIG. 6, a relay lens 10 that relays the pupil of the objective lens 4 may be disposed between the dichroic mirror 8 and the image acquisition element 7, and the coded aperture 5 may be disposed at a position optically conjugate with a pupil formed by the relay lens 10.

Accordingly, a three-dimensional fluorescence image of the sample X can be acquired within a short period of time.

In this case, it is necessary to ensure space for installing the relay lens 10 and the coded aperture 5. However, since the excitation light does not have to pass through the coded aperture 5, there is an advantage in that selection can be made from a larger number of types of glass materials.

Furthermore, as an alternative to this embodiment in which the microscope device 1 is of a so-called epi-illumination type that radiates excitation light onto the sample X via the objective lens 4 and collects fluorescence by means of the objective lens 4, the excitation light may be radiated onto the sample X without the intervention of the objective lens 4. In that case, the coded aperture 5 can be disposed at the pupil position of the objective lens 4, and the flat glass plate constituting the coded aperture 5 can be selected from a larger number of types of glass materials.

Furthermore, as an alternative to this embodiment in which the microscope device 1 uses the light field technology by disposing the microlens array 9 at the image acquisition surface of the image acquisition element 7, the microlens array 9 may be omitted. Three-dimensional information of the sample X can be acquired in accordance with a depth increasing effect due to the coded aperture 5. Moreover, in this embodiment, the microscope device 1 may include an image processor that executes image processing by using at least one of light field technology and coded aperture technology.

As a result, the above-described embodiment leads to the following aspects.

An aspect of the present invention is directed to a microscope device including a stage on which a sample is placed, an objective lens that collects fluorescence generated in the sample as a result of the sample placed on the stage being irradiated with excitation light, a phase plate through which the fluorescence collected by the objective lens is transmitted, an imaging lens that focuses the fluorescence transmitted through the phase plate, and an image acquisition element that acquires a fluorescence image of the sample focused by the imaging lens. The phase plate is disposed at a pupil position of the objective lens or at a position optically conjugate with the pupil position.

According to this aspect, the sample is placed on the stage and is irradiated with the excitation light, so that the fluorescence generated at the irradiation position of the excitation light is collected by the objective lens. Subsequently, the fluorescence is transmitted through the phase plate and is focused by the imaging lens, so that the fluorescence image of the sample is formed on the image acquisition element. Because the phase plate is disposed at the pupil position of the objective lens or at the position optically conjugate with the pupil position, a fluorescence image with an increased focal depth is acquired by the image acquisition element. Accordingly, an image including three-dimensional information of a sample can be acquired within a short period of time.

In the above aspect, the microscope device may further include a dichroic mirror that causes the excitation light emitted from a light source to enter the objective lens and diverts the fluorescence collected by the objective lens from an optical path of the excitation light.

According to this configuration, the excitation light emitted from the light source passes through the dichroic mirror, subsequently enters the objective lens, and is radiated onto the sample. When the fluorescence generated in the sample passes through the dichroic mirror, the excitation light is diverted toward the image acquisition element from the optical path of the excitation light. Accordingly, a so-called epi-illumination microscope device can be provided.

In the above aspect, the phase plate may be disposed between the dichroic mirror and the imaging lens.

According to this configuration, the excitation light does not pass through the phase plate, so that the occurrence of fluorescence caused by the excitation light in the phase plate can be prevented, thereby preventing a situation where an image of the fluorescence is acquired as an image of stray light.

In the above aspect, the phase plate may be disposed toward the stage relative to the dichroic mirror.

According to this configuration, the phase plate can be disposed at the pupil position of the objective lens or at a position near the pupil position, so that size reduction of the microscope device can be achieved, as compared with a case where the phase plate is disposed at a position optically conjugate with the pupil position.

In the above aspect, the excitation light may be ultraviolet light, and the phase plate may be formed of a material that satisfies the conditional expressions indicated below:

1.43≤nd≤1.61

62≤νd≤95

where nd denotes a refractive index at a d-line, and νd denotes an Abbe number at the d-line.

According to this configuration, the phase plate is disposed at the pupil position of the objective lens or at a position near the pupil position, so that the occurrence of fluorescence caused by the excitation light passing through the phase plate can be suppressed, while size reduction of the microscope device can be achieved.

In the above aspect, the phase plate may have a shape expressed with an expression indicated below:

z=k(x³+y³)

where z denotes a direction of an optical axis, x and y denote coordinates in two directions orthogonal to the optical axis and orthogonal to each other, and k denotes a freely-chosen rational number.

In the above aspect, the microscope device may further include a microlens array disposed between the imaging lens and the image acquisition element.

In the above aspect, the material of the phase plate may be synthetic quartz.

In the above aspect, the microscope device may further include an image processor that executes image processing by using at least one of light field technology and coded aperture technology.

Another aspect of the present invention is directed to a microscope device including a light source that emits excitation light, a dichroic mirror that receives the excitation light from the light source, an objective lens that is disposed toward a sample relative to the dichroic mirror and that focuses the excitation light reflected by the dichroic mirror onto the sample, a phase plate that is disposed toward the sample relative to the dichroic mirror and at a pupil position of the objective lens or at a position optically conjugate with the pupil position and that receives the excitation light reflected by the dichroic mirror, an imaging lens that focuses fluorescence generated as a result of the sample being irradiated with the excitation light, and an image acquisition element that acquires a fluorescence image of the sample focused by the imaging lens. The fluorescence generated as a result of the sample being irradiated with the excitation light passes through the objective lens and the phase plate, enters the dichroic mirror, is transmitted through the dichroic mirror, and is focused by the imaging lens, so that the fluorescence image of the sample is formed on the image acquisition element.

The present invention is advantageous in that an image including three-dimensional information of a sample can be acquired within a short period of time.

### REFERENCE SIGNS LIST

1 microscope device
2 stage
3 light source
4 objective lens
5 coded aperture (phase plate)
6 imaging lens
7 image acquisition element
8 dichroic mirror
9 microlens array
X sample

1. A microscope device comprising:
a stage on which a sample is placed;
an objective lens that collects fluorescence generated in the sample as a result of the sample placed on the stage being irradiated with excitation light;
a phase plate through which the fluorescence collected by the objective lens is transmitted;
an imaging lens that focuses the fluorescence transmitted through the phase plate; and
an image acquisition element that acquires a fluorescence image of the sample focused by the imaging lens,
wherein the phase plate is disposed at a pupil position of the objective lens or at a position optically conjugate with the pupil position.

2. The microscope device according to claim 1, further comprising:
a dichroic mirror that causes the excitation light emitted from a light source to enter the objective lens and diverts the fluorescence collected by the objective lens from an optical path of the excitation light.

3. The microscope device according to claim 2,
wherein the phase plate is disposed between the dichroic mirror and the imaging lens.

4. The microscope device according to claim 2,
wherein the phase plate is disposed toward the stage relative to the dichroic mirror.

5. The microscope device according to claim 4,
wherein the excitation light is ultraviolet light, and
wherein the phase plate is formed of a material that satisfies conditional expressions indicated below:
1.43≤nd≤1.61
62≤νd≤95
where nd denotes a refractive index at a d-line, and νd denotes an Abbe number at the d-line.

6. The microscope device according to claim 1,
wherein the phase plate has a shape expressed with an expression indicated below:
z=k(x³+y³)
where z denotes a direction of an optical axis, x and y denote coordinates in two directions orthogonal to the optical axis and orthogonal to each other, and k denotes a freely-chosen rational number.

7. The microscope device according to claim 1, further comprising:
a microlens array disposed between the imaging lens and the image acquisition element.

8. The microscope device according to claim 5,
wherein the material of the phase plate is synthetic quartz.

9. A microscope device comprising:
a light source that emits excitation light;
a dichroic mirror that receives the excitation light from the light source;
an objective lens that is disposed toward a sample relative to the dichroic mirror and that focuses the excitation light reflected by the dichroic mirror onto the sample;
a phase plate that is disposed toward the sample relative to the dichroic mirror and at a pupil position of the objective lens or at a position optically conjugate with the pupil position and that receives the excitation light reflected by the dichroic mirror;
an imaging lens that focuses fluorescence generated as a result of the sample being irradiated with the excitation light; and
an image acquisition element that acquires a fluorescence image of the sample focused by the imaging lens,
wherein the fluorescence generated as a result of the sample being irradiated with the excitation light passes through the objective lens and the phase plate, enters the dichroic mirror, is transmitted through the dichroic mirror, and is focused by the imaging lens, so that the fluorescence image of the sample is formed on the image acquisition element.
